(19) United States
(12) Patent Application Publication
(10) Pub. No.: US 2025/0172297 A1
(43) Pub. Date: May 29, 2025

(54) AIR SEPARATOR WITHIN A SOLAR AIR COLLECTOR

(71) Applicant: TRIGO ENERGIES INC., Trois-Rivières (CA)

(72) Inventor: Christian VACHON, Trois-Rivières (CA)

(21) Appl. No.: 18/859,593

(22) PCT Filed: Mar. 28, 2023
(86) PCT No.: PCT/CA2023/050416

§ 371 Date: Oct. 24, 2024

Related U.S. Application Data
(60) Provisional application No. 63/363,825, filed on Apr. 29, 2022.

(51) Int. Cl. F24D 5/00; F24D 5/04; F24H 3/00; F24S 10/25; F24S 20/66; F24S 70/225

(52) U.S. Cl. CPC F24D 5/005; F24D 5/04; F24H 3/00; F24S 10/25; F24S 20/66; F24S 70/225

(57) ABSTRACT

A solar air heating system comprises a solar collector. The collector comprises a front glazing and a perforated absorber behind the glazing. A front plenum is defined between the front glazing and the absorber. A back plenum is defined between the absorber and a back wall. The front and back plenums are fluidly connected through the perforated absorber. A flow separator divides the back plenum into an inlet chamber and an outlet chamber. The inlet and outlet chambers are fluidly connected via the front plenum. The inlet chamber has an air inlet. The outlet chamber has an air outlet. The front plenum has a smaller air exchange interface with the inlet chamber than with the outlet chamber so that a temperature gain is greater when the air flows from the front plenum to the outlet chamber than when the air flows from the inlet chamber to the front plenum.

### TECHNICAL FIELD

The disclosure relates generally to air systems for buildings and industrial processes and, more particularly, to a glazed solar air-heating collector with a double-pass perforated absorber.

### BACKGROUND OF THE ART

Solar collectors, such as solar air-heating collectors, are widely known in the art and are used on houses, commercial buildings, and other structures to provide heating by harnessing solar energy. Such solar collectors are subject to thermal losses to the environment. The higher the looses to the cold environment, the lower the overall thermal efficiency of the collector. Improvements are thus desirable.

### SUMMARY

In one aspect, there is provided a solar air heating collector comprising: an enclosure having a front glazing and a back surface defining a plenum therebetween; a perforated absorber disposed inside the plenum, the perforated absorber dividing the plenum into a back plenum between the back surface and the perforated absorber and a front plenum between the front glazing and the perforated absorber, the back plenum fluidly connected to the front plenum through perforations in the perforated absorber, the back plenum having an air inlet and an air outlet; and an air separator extending across the back plenum from the back surface to the perforated absorber, the air separator located closer to the air inlet than the air outlet.

According to another aspect, the air separator forces the air to flow in a forward direction from the back plenum to the front plenum and in a backward direction from the front plenum to the back plenum, the position of the air separator in the back plenum providing for a lower flow rate through the perforated absorber in the forward direction than in the backward direction.

In another aspect, there is provided a solar air heating system for heating indoor air from a building, the system comprising: a glazed solar air collector adapted to be mounted to a building wall of the building, the glazed solar air collector comprising: a front glazing transparent to solar radiation, the front glazing having opposed front and back faces, the front face of the front glazing forming an external surface of the glazed solar air collector and being directly exposed to the ambient; a solar radiation absorber disposed behind the front glazing for absorbing solar radiation passing through the front glazing; a front plenum defined between the back face of the front glazing and an opposed front face of the solar radiation absorber, a back plenum defined between the solar radiation absorber and the building wall, the front plenum and the back plenum fluidly connected through perforations defined in the solar radiation absorber; and an internal air flow separator extending across the back plenum, the internal air flow separator dividing the back plenum into an inlet chamber and an outlet chamber, the inlet chamber and the outlet chamber fluidly connected via the front plenum; the inlet chamber having an air inlet for receiving air from inside the building, the outlet chamber having an air outlet for discharging heated air back into the building, the front plenum having a smaller air exchange interface with the inlet chamber than with the outlet chamber.

### DESCRIPTION OF THE DRAWINGS

Reference is now made to the accompanying figures in which:

FIG. 1 is a schematic cross-section elevation view of a solar air-heating system including a closed-loop glazed collector with a double-pass perforated absorber and an internal air flow separator located at mid-height between an air inlet and an air outlet of the collector;

FIG. 2 is a schematic cross-section elevation view of a glazed collector with the internal air flow separator positioned in a lower half of the collector adjacent to the collector air inlet;

FIG. 3 is a graph showing a temperature rise distribution through the collector air path stages as a function of the position of the internal air flow separator relative to the collector air inlet;

FIG. 4 is a graph of the temperature rise vs. the air flow in the first and second passes of the air through the perforated absorber;

FIG. 5 is a graph illustrating the effect of the separator location on the collector solar efficiency curve; and

FIGS. 6a to 6d are schematic views illustrating various possible collector elevations with different possible locations of the internal air flow separator relative to the air inlet and air outlet of the collector.

### DETAILED DESCRIPTION

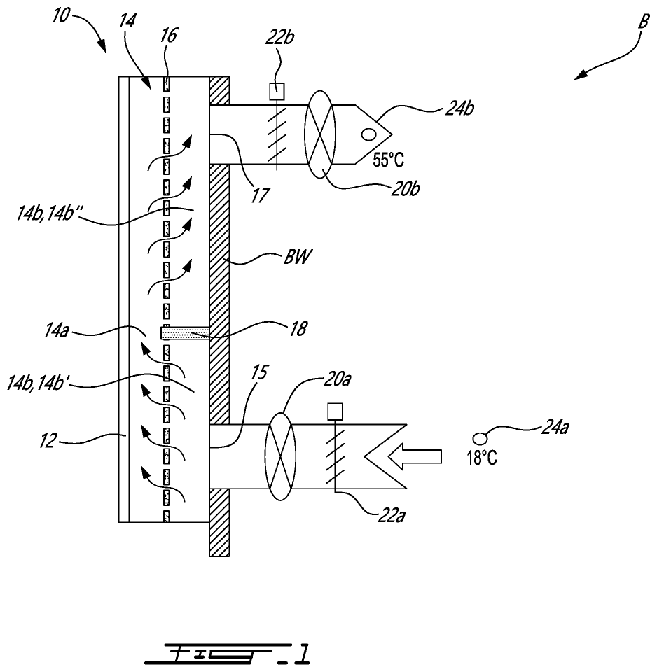

FIG. 1 illustrates an embodiment of a solar air-heating system comprising a glazed solar air-heating collector 10 adapted to be mounted to a south facing wall (BW) or a roof of a building B for heating air with solar energy. According to one application, the system may be configured as a closed-looped system configured to withdraw air from inside a building or process (for example indoor air at 18 Celsius) run it through the collector 10 to increase the air temperature, and pulse it back into the building/process at a higher temperature (for example 20 Celsius and above). As long as the collector inlet air temperature is increased within the collector 10, the solar air-heating system may remain operational. However, when it is determined that the solar energy available is no longer sufficient to heat the recirculated air, for example at night, the solar air-heating system may be turned off.

As shown in FIG. 1, the glazed solar air-heating collector 10 may comprise an enclosure having a front glazing 12 exposed to the ambient and mounted to a building wall BW by an appropriate frame and bracket/fastener assembly to form an air plenum 14. Insulation may be provided along the sides and the back of the enclosure to minimize heat loss to ambient air. According to the illustrated embodiment, the back surface of the enclosure is the building wall BW. However, it is understood that the back surface could be any other suitable surface. The front glazing 12 is transparent to solar radiation and may be composed of glass, polycarbonate or any other suitable materials transparent to sunrays. For instance, the front glazing may be formed of high-light-transmissive coplanar polycarbonate sheets. According to one embodiment, the polycarbonate sheets may be selected to have an insulation value over 1,5 W/m2·K. A perforated solar radiation absorber 16 is disposed inside the plenum 14 at a distance behind the front glazing 12 for absorbing solar radiation passing through the front glazing 12. The perforated solar radiation absorber 16 can take various forms. For instance, it can be provided in the form of side-by-side perforated metal panels having a metal surface that has very little emissivity in the thermal energy spectral range, such as a selective surface (emissivity about 3% or less). For instance, the coplanar absorber panels may be coated on the sun exposed side thereof with a selective coating. The term “selective coating” is herein generally used to refer to a solar radiation absorbing coating for absorbing solar radiation with low infrared heat radiation emission. The perforation in the absorber 16 can be uniformly distributed over the surface thereof or otherwise suitably arranged to promote a desired flow distribution over the absorber surface.

As shown in FIG. 1, the perforated solar radiation absorber 16 divides the plenum 14 into a front plenum 14a and a back plenum 14b. The front plenum 14a is defined between the back face of the front glazing 12 and an opposed front face of the solar radiation absorber 16. According to the illustrated wall mounted embodiment, the back plenum 14b is defined between the solar radiation absorber 16 and the building wall BW. The front plenum 14a and the back plenum 14b are fluidly connected through the perforations defined in the perforated absorber 16. The back plenum 14b is itself subdivided into an inlet chamber 14b′ (first sub back plenum) and outlet chamber 14b″ (second sub back plenum) by an internal air flow separator 18 extending across the back plenum 14b between the perforated absorber 16 and the building wall BW. The inlet chamber 14b′ has an air inlet 15 fluidly connected to a source of indoor air inside the exemplified building B. The outlet chamber 14b″ has an air outlet 17 fluidly connected to a return duct or the like for returning the recirculated air into the building B after its passage through the collector 10. The separator 18 can be made of a solid piece of high-temperature resistant neoprene, metal or non-metallic material, sealant, etc.

As shown in FIG. 1, the air heating system further comprises a suitable controller (not shown) operatively connected to air moving means, such as fans 20a, 20b, to selectively draw air from the building into the collector 10 and pulse the heated air back into the building. Other equipment, such as air motorized dampers 22a, 22b and temperature sensors/probes 24a, 24b can be operatively connected to the controller to control/regulate the flow of recirculated air through the collector 10.

In operation, air from inside the building B is drawn into the inlet chamber 14b′ (i.e. the first back plenum) via the air inlet 15. In its first air path stage, the air flows from the inlet chamber 14b′ to the front plenum 14a through the perforated absorber 16. This constitutes the first pass of the air through the perforated absorber 16. Then, in a second air path stage, the air flows along the front plenum 14a between the front glazing 12 and the absorber 16. In a third air path stage, the air flows from the front plenum 14a to the outlet chamber 14b″ (the second back plenum) through the perforated absorber 16. This constitutes the second pass of the air through the perforated absorber 16, the first and second passes occurring in opposite forward and backward directions as can be appreciated from the flow arrows in FIG. 1. From the outlet chamber 14b″, the heated air is returned back into the building B via the air outlet 17 of the collector 10.

From the foregoing, it can be appreciated that the above-described embodiment provides a closed-loop system with a perforated absorber 16 through which the solar-heated air travels twice: once forward from the first back plenum 14b′ to the front plenum 14a and once backward from the front plenum 14a to the second back plenum 14b″. This provides for a collector with a double-pass perforated absorber.

The inventor has found that a strategic positioning of the internal flow separator 18 relative to the air inlet 15 and the air outlet 17 can positively affect flow distribution and increase the overall thermal efficiency of the solar air heating system. That is the positioning of the internal air flow separator 18 can be selected to control the air temperature rise within the collector 10 to increase thermal efficiency and reduce heat losses to the environment through the front glazing 12. As will be seen hereinafter, the position of the internal air flow separator 18 relative to the air inlet 15 may be used to promote and control uniform air flow distribution across the whole collector face area.

A glass-covered solar collector like the one described above is subject to thermal losses to the environment through the front glazing 12. The aim of a solar air-heating collector is to increase the supply air temperature above that of the returning air. Yet the higher the air temperature within the collector 10, the higher the heat losses to the cold environment, and hence the lower the overall thermal efficiency and heat output. In reverse, keeping the collector's inner temperature as low as possible is an objective if we wish to increase the collector's efficiency.

As noted above, the internal air flow separator 18 makes the air cross the perforated absorber 16 twice in opposite directions (once forward/outward and once backward/inward), thereby dividing the air flow path into three parts/stages:
(1)—The air flows forward in a first pass through the perforated absorber 16;
(2)—The air travels in front of the absorber 16, between the front glazing 12 and the absorber 16 itself; and
(3)—The air flows backward in a second pass through the perforated absorber 16, before the heated air is expelled into the space/process to be heated.

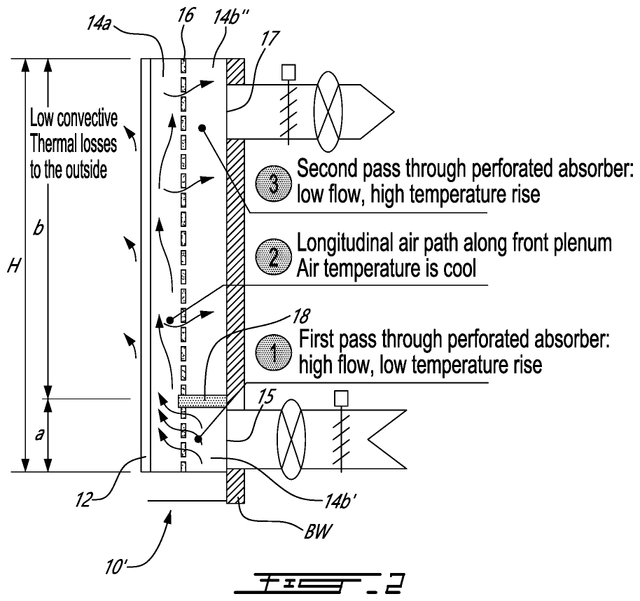

It is within stages no. (1) and (3) of the air flow path that the air absorbs heat from the absorber 16, by passing air through the hot absorber when exposed to solar radiation. It is mainly within stage no. (2) of the air flow path that the collector 10 loses heat to the environment. In this part, the temperature of the air should thus be kept to a minimum. In order to keep the internal air temperature as low as possible, it is herein suggested to position the internal air flow separator 18 closer to the air inlet 15 than to the air outlet 17. FIG. 2 shows an embodiment of a collector 10′ in which the internal flow separator 18 is strategically positioned adjacent to the air inlet 15. In this way, the first and second passes through the perforated absorber 16 are not equal in terms of through flow: By positioning the separator 18 at a short distance from the air inlet 15, as for instance illustrated in FIG. 2, the first forward pass through the absorber 16 can be done at a high through flow (e.g. 8-10 cfm per sq.ft.). This provides for a low temperature rise of the air in the first part of the air flow path. Conversely, the positioning of the separator 18 in the lower half of the collector close to the air inlet 15 provides for a greater air exchange interface between the front plenum 14a and the outlet chamber 14b″ (the second back plenum) via the perforated absorber 16. The second backward pass can thus occur at a low through flow (e.g. 1-3 cfm per sq.ft.). This provides for a greater temperature rise as compared to the first high flow pass of the air through the perforated absorber 16. By so controlling the temperature gain of the air as it flows through the collector 10′, heat losses to the environment through the front glazing 12 can be minimized and, thus, the thermal efficiency of the collector can be improved.

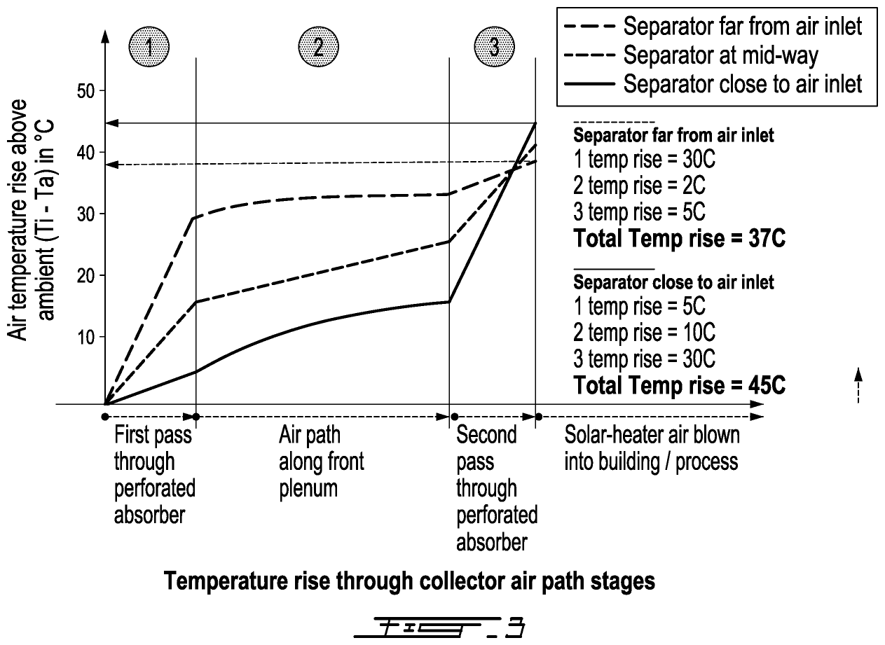

FIG. 3 illustrates the impact of the positioning of the flow separator 18 on the temperature rise in the three above described flow stages (1), (2) and (3) of the air through the collector. It can be appreciated that by positioning the separator 18 close to the air inlet 15, the temperature rise may be concentrated in the third stage of the flow path, thereby minimizing heat looses in the front plenum 14a (second stage of the flow path), and thus providing for better overall thermal efficiency.

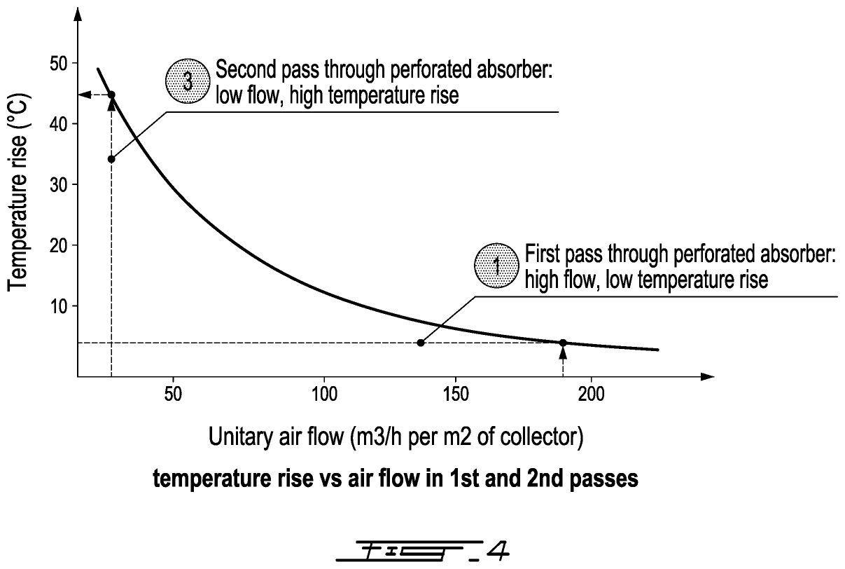

FIG. 4 illustrates that with the separator 18 close to the air inlet 15, the first pass through the perforated absorber 16 provides for a high flow and a low temperature rise, whereas the second pass through the perforated absorber 16 provide a much smaller flow but a much higher temperature rise. The strategic positioning of the flow separator 18 thus allows having very different impacts on the air during the first and second flow passes through the perforated absorber 16.

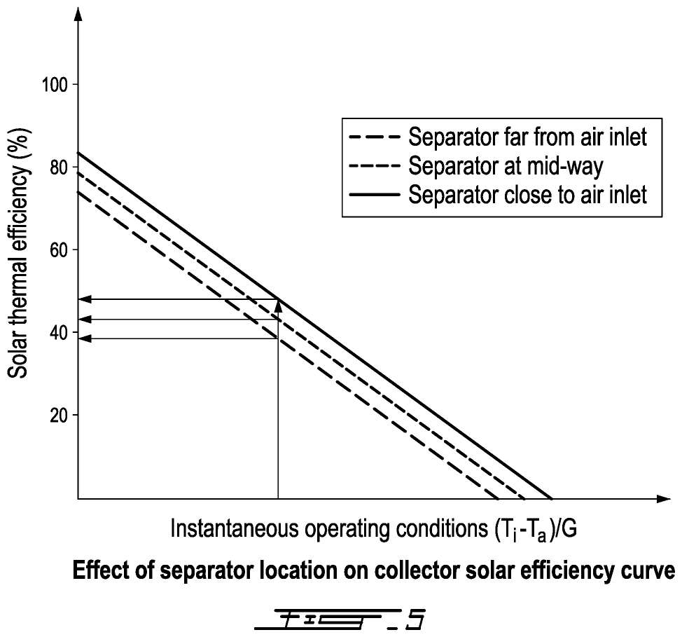

From FIG. 5, it can be appreciated that better solar thermal efficiency can be obtained by positioning the air flow separator 18 closer to the air inlet 15 than from the air outlet 17.

According to some embodiment, the separator 18 can be located at any distance ratio (a/H) lower than 0.5 to achieve better results. According to the illustrated embodiment, the air inlet and the air outlet are vertically spaced-apart, and the dimension (a) generally correspond to a height of the inlet chamber 15 whereas (H) correspond to the height of the perforated absorber (i.e. the distance between the air inlet and the air outlet). A ratio (a/H) of about 0.15 to about 0.25 can be deemed best practice, especially if the absorber 16 has homogeneous porosity over the whole surface thereof. Common absorbers in normal practice can handle through flows of 2 to 10 cfm per sq.ft (35 to 180 m3/h) of air per surface area. If the short section “a” in FIG. 2 works at maximum through flow (10 cfm/ft2) and the wide section “b” works at minimum through flow, then the height ratios a/b= 2/10=⅕ and a/H=⅙.

However, the porosity values (in %) may vary between section “a” and section “b”, so that the overall pressure drop of the whole collector—and within the collector sections “a” and “b” can be controlled. If porosities in “a” and “b” are different, then this gives increased flexibility for height ratios.

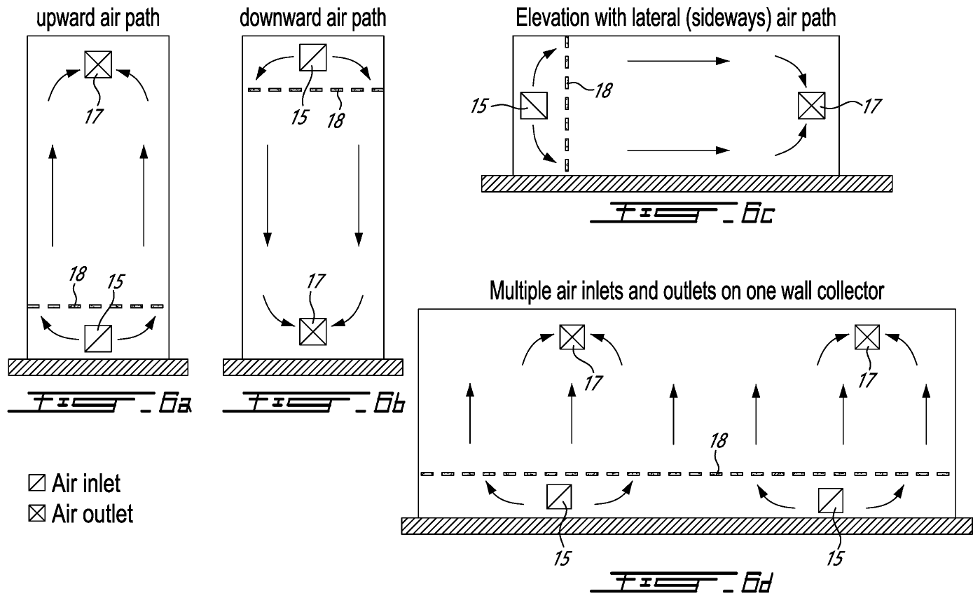

As shown in FIGS. 6a to 6d, various air inlet/air outlet and flow separator configurations are contemplated. As shown in FIG. 6a and as described hereinabove, the air inlet 15 and the air outlet 17 can be respectively disposed at the lower and upper ends of the collector with the separator 18 disposed adjacent to the air inlet 15 in the lower end portion of the collector. It is understood that the air inlet 15 and the air outlet 17 could each include multiple inlet ports and outlet ports, as shown in FIG. 6d. According to another variant, the air inlet 15 and the separator 18 could be provided at the upper end of the collector while the air outlet 17 is at the collector lower end, thereby providing for a downward air path as shown in FIG. 6b. According to a further variant illustrated in FIG. 6c, the air inlet 15 and the air outlet 17s could be disposed on the opposed left/right sides of the collector to provide for a lateral/sideways air path. In this case, the separator 18 would have a vertical orientation but would still be located adjacent to the air inlet 15. According to this sideways air path embodiment, the dimensions (a), (b) and (H) are measured horizontally between the air inlet and the air outlet.

According to at least some of the above described embodiments, satisfactory results may be obtained with the following operation parameters:

Unit air flow range (per m2 of collector): 20 to 200 m³/h/m²

Preferred air flow range: 20 to 70 m³/h/m²

Linear air velocity within plenum (1200 fpm (m/s))

Porosity of exposed perforated plate: 2% to 8%.

It can thus be appreciated that the strategic positioning of the air flow separator closer to the air inlet 15 may allow balancing air flows between the absorber portions of air moving outward and moving inward. It may also allow reducing the air temperature in the front plenum 14a that finds itself in direct convective contact with the front glazing 12. In short, the strategic positioning of the flow separator may allow increasing the overall thermal efficiency of collector.

It is noted that the separator location does not affect the overall installation costs of the collector. Indeed, no additional parts are required and the installation time remain unchanged. However, the strategic positioning the internal air flow separator will affect the collector solar heat output over the lifetime of the collector. An identical investment brings about greater heat production.

Inversely, the strategically positioned separator can be used to lower the cost of the overall collector (in that case, with a cheaper glazing). Starting from a given design with an expensive polycarbonate or glass cover, with given light transmissivity (%) and thermal resistance value (W/m²·K), then positioning the separator near the air inlet 15 can allow the use of a cheaper glazing, with lower light transmissivity or lower thermal resistance, to achieve the same initial heat output result. For instance, it may allow using a front glazing having insulation value below 1 W/m²·K.

An embodiment of the present disclosure is a solar air-heating collector comprising: an enclosure having a front glazing and a back surface defining a plenum therebetween; a perforated absorber disposed inside the plenum, the perforated absorber dividing the plenum into a back plenum between the back surface and the perforated absorber and a front plenum between the front glazing and the perforated absorber, the back plenum fluidly connected to the front plenum through perforations in the perforated absorber, the back plenum having an air inlet and an air outlet; and an air separator extending across the back plenum from the back surface to the perforated absorber, the air separator located closer to the air inlet than the air outlet.

In one or more embodiments described in the preceding paragraph, the air separator subdivides the back plenum into an inlet chamber and an outlet chamber, the inlet chamber configured for receiving air from the air inlet, the outlet chamber configured to discharge air via the air outlet, wherein the perforated absorber has a first surface area defining a front face of the inlet chamber, and a second surface area defining a front face of the outlet chamber, the second surface area greater than the first surface area.

In one or more embodiments described above, the first surface area is configured to provide a higher air flow rate through the perforated absorber than the second surface area.

In one or more embodiments described above, the first surface area and the second surface area have a same porosity. In one or more embodiments described above, the first surface area and the second surface area have a different porosity. In one or more embodiments described above, the air inlet and the air outlet are spaced-apart along a first direction, wherein the inlet chamber has a length (a) along the first direction, the outlet chamber has a length (b) along the first direction, and the perforated absorber has a length (H) along the first direction, and wherein a ratio (a/H) is less than 0.5. In one or more embodiments described above, the ration (a/H) is comprised between 0.15 and 0.25. In one or more embodiments described above, a ratio (a/b) is less than 0.5 and is preferably equal to about 0.25. In one or more embodiments described above, the perforated absorber is coated on a front sun exposed side thereof with a selective coating. In one or more embodiments described above, the air separator includes a solid piece of high-temperature resistant neoprene.

Another embodiment of the present disclosure is a solar air-heating system for heating indoor air from a building, the system comprising: a glazed solar air collector adapted to be mounted to a building wall of the building, the glazed solar air collector comprising: a front glazing transparent to solar radiation, the front glazing having opposed front and back faces, the front face of the front glazing forming an external surface of the glazed solar air collector and being directly exposed to the ambient; a solar radiation absorber disposed behind the front glazing for absorbing solar radiation passing through the front glazing; a front plenum defined between the back face of the front glazing and an opposed front face of the solar radiation absorber; a back plenum defined between the solar radiation absorber and the building wall, the front plenum and the back plenum fluidly connected through perforations defined in the solar radiation absorber; and an internal air flow separator extending across the back plenum, the internal air flow separator dividing the back plenum into an inlet chamber and an outlet chamber, the inlet chamber and the outlet chamber fluidly connected via the front plenum; the inlet chamber having an air inlet for receiving air from inside the building, the outlet chamber having an air outlet for discharging heated air back into the building, the front plenum having a smaller air exchange interface with the inlet chamber than with the outlet chamber.

In one of more of embodiments described in the preceding paragraph, the internal air flow separator is positioned closer to the air inlet than the air outlet so that a first temperature gain of the air while flowing from the inlet chamber to the front plenum through the solar radiation absorber is less than a second temperature gain of the air while flowing from the front plenum to the outlet chamber through the solar radiation absorber. In one or more embodiments described above, the internal air flow separator is positioned closer to the air inlet than the air outlet so that a first pass of the air through the solar radiation absorber from the inlet chamber to the front plenum has a higher flow rate and a lower temperature rise than a second pass of the air through solar radiation absorber from the front plenum to the outlet chamber of the back plenum. In one or more embodiments described above, the solar radiation absorber has a length (H) along a direction between the air inlet and the air outlet, the inlet chamber has a length (a) along the direction, and a ratio (a/H) is less than 0.5. In one or more embodiments described above, the ratio (a/H) is comprised between 0.15 and 0.25. In one or more embodiments described above, the solar radiation absorber has a selective coating on the front face thereof, the selective coating having an emissivity of 3% or less, and the solar radiation absorber has a porosity comprised between 2% to 8% over a total surface area thereof.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

1. A solar air-heating collector comprising:
an enclosure having a front glazing and a back surface defining a plenum therebetween;
a perforated absorber disposed inside the plenum, the perforated absorber dividing the plenum into a back plenum between the back surface and the perforated absorber and a front plenum between the front glazing and the perforated absorber, the back plenum fluidly connected to the front plenum through perforations in the perforated absorber, the back plenum having an air inlet and an air outlet; and
an air separator extending across the back plenum from the back surface to the perforated absorber, the air separator located closer to the air inlet than the air outlet.

2. The solar air-heating collector according to claim 1, wherein the air separator subdivides the back plenum into an inlet chamber and an outlet chamber, the inlet chamber configured for receiving air from the air inlet, the outlet chamber configured to discharge air via the air outlet, wherein the perforated absorber has a first surface area defining a front face of the inlet chamber, and a second surface area defining a front face of the outlet chamber, the second surface area greater than the first surface area.

3. The solar air-heating collector according to claim 2, wherein the first surface area is configured to provide a higher air flow rate through the perforated absorber than the second surface area.

4. The solar air-heating collector according to claim 3, wherein the first surface area and the second surface area have a same porosity.

5. The solar air-heating collector according to claim 3, wherein the first surface area and the second surface area have a different porosity.

6. The solar air-heating collector according to claim 1, wherein the air inlet and the air outlet are spaced-apart along a first direction, wherein the inlet chamber has a length (a) along the first direction, the outlet chamber has a length (b) along the first direction, and the perforated absorber has a length (H) along the first direction, and wherein a ratio (a/H) is less than 0.5.

7. The solar air-heating collector according to claim 6, wherein the ration (a/H) is comprised between 0.15 and 0.25.

8. The solar air-heating collector according to claim 6, wherein a ratio (a/b) is less than 0.5 and is preferably equal to about 0.25.

9. The solar air-heating collector according to claim 1, wherein the perforated absorber is coated on a front sun exposed side thereof with a selective coating.

10. The solar air-heating collector according to claim 1, wherein the air separator includes a solid piece of high-temperature resistant neoprene.

11. A solar air-heating system for heating indoor air from a building, the system comprising:
a glazed solar air collector adapted to be mounted to a building wall of the building, the glazed solar air collector comprising:
a front glazing transparent to solar radiation, the front glazing having opposed front and back faces, the front face of the front glazing forming an external surface of the glazed solar air collector and being directly exposed to the ambient;
a solar radiation absorber disposed behind the front glazing for absorbing solar radiation passing through the front glazing;
a front plenum defined between the back face of the front glazing and an opposed front face of the solar radiation absorber;
a back plenum defined between the solar radiation absorber and the building wall, the front plenum and the back plenum fluidly connected through perforations defined in the solar radiation absorber; and
an internal air flow separator extending across the back plenum, the internal air flow separator dividing the back plenum into an inlet chamber and an outlet chamber, the inlet chamber and the outlet chamber fluidly connected via the front plenum; the inlet chamber having an air inlet for receiving air from inside the building, the outlet chamber having an air outlet for discharging heated air back into the building, the front plenum having a smaller air exchange interface with the inlet chamber than with the outlet chamber.

12. The solar air-heating system according to claim 11, wherein the internal air flow separator is positioned closer to the air inlet than the air outlet so that a first temperature gain of the air while flowing from the inlet chamber to the front plenum through the solar radiation absorber is less than a second temperature gain of the air while flowing from the front plenum to the outlet chamber through the solar radiation absorber.

13. The solar air-heating system according to claim 11, wherein the internal air flow separator is positioned closer to the air inlet than the air outlet so that a first pass of the air through the solar radiation absorber from the inlet chamber to the front plenum has a higher flow rate and a lower temperature rise than a second pass of the air through solar radiation absorber from the front plenum to the outlet chamber of the back plenum.

14. The solar air-heating system according to claim 11, wherein the solar radiation absorber has a length (H) along a direction between the air inlet and the air outlet, wherein the inlet chamber has a length (a) along the direction, and wherein a ratio (a/H) is less than 0.5.

15. The solar air-heating system according to claim 14, wherein the ratio (a/H) is comprised between 0.15 and 0.25.

16. The solar air-heating system according to claim 11, wherein the solar radiation absorber has a selective coating on the front face thereof, the selective coating having an emissivity of 3% or less, and wherein the solar radiation absorber has a porosity comprised between 2% to 8% over a total surface area thereof.
